(19) United States
(12) Patent Application Publication
(10) Pub. No.: US 2018/0153346 A1
(43) Pub. Date: Jun. 7, 2018

(54) DUAL FUEL GRILL HAVING SLIDABLE DRAWER FOR SOLID FUEL

(71) Applicant: A&J Manufacturing, LLC, St. Simons, GA (US)

(72) Inventors: John Lee Simms, II, Atlanta, GA (US); Michael Hermes, Atlanta, GA (US)

(21) Appl. No.: 15/821,649

(22) Filed: Nov. 22, 2017

Related U.S. Application Data
(60) Provisional application No. 62/425,485, filed on Nov. 22, 2016.

(51) Int. Cl. A47J 37/07

(52) U.S. Cl. CPC A47J 37/0713; A47J 37/0786

(57) ABSTRACT

A grilling structure that has at least one slidable drawer for burning solid fuel for cooking, and a plurality of gas burner tubes are located under the slidable drawer for cooking with gas. Both the slidable drawer and gas burner tubes are beneath the same cooking surface of the grill body. The slidable drawer includes a plurality of passages therethrough that are substantially vertically positioned above the plurality of burner tubes when the slidable drawer is slid into the grill body such that debris which falls through the passages of the slidable drawer does not substantially impact the plurality of gas burner tubes. The grill body can include an ash collection drawer in its base to catch debris, such as ash and food drippings, and the slidable drawer can have an extendable shield that extends under it as the slidable drawer is pulled outwardly from the grill base.

### CROSS-REFERENCE TO RELATED APPLICATION

This application claims the benefit of U.S. Provisional Patent Application No. 62/425,485, titled “DUAL FUEL GRILL HAVING SLIDABLE DRAWER FOR SOLID FUEL,” filed Nov. 22, 2016, the entirety of which is incorporated herein by this reference.

### BACKGROUND OF THE INVENTION

### 1. Field of the Invention

The present invention generally relates to food-cooking grills. More particularly, the present invention generally relates to outdoor barbeque grills that can use both gas and solid fuel to cook food.

### 2. Description of the Related Art

Barbeque enthusiasts will barbeque foods using various methods of cooking. For example, sometimes barbecuing with a charcoal based fuel (e.g., charcoal briquettes) is desired. Other times, barbecuing with a wood based fuel is desired (e.g., for a smoking process). Both charcoal and wood can be considered “solid” cooking fuels. At other times, barbequing with a gas-based fuel (e.g., propane) is desired. Furthermore, other types of fuel may be needed to satisfy the barbecuing objective, be it pure cooking by combustion or flavoring from the burning of certain fuels, such as types of wood.

Currently, there are typically single fuel barbecue grills that can only prepare barbecue in a single mode, such as with gas only or with solid fuel only. There are several grills that exist that allow one to use either gas or solid fuel. In one type of grill, a single cooking surface is heated by either gas burners or solid fuel held in a tray over the gas burners such that only one type of fuel is used to cook food on the single grill at once. These single unit grills often have difficulty in keeping the solid fuel from spilling onto and adversely affecting the gas burner tubes. Furthermore, it is difficult to clean the solid fuel tray and one has to wait until it cools before removing the tray from its position over the gas burners to be able to then use the gas burners to cook food.

There are other duel fuel grills that have a solid fuel cooking surface and a gas burner cooking surface in separate, independently operable cooking units on the same structure that can allow a person to simultaneously cook food with both types of fuel in the same grill structure. However, these dual cooking unit grills are often very large and heavy, taking up a large physical area of space to accommodate the grill.

### SUMMARY OF THE INVENTION

Briefly described, in a preferred embodiment, the present invention is a grill structure including a cooking surface, a movable cover over the cooking surface, a slidable drawer for solid fuel, and a base. The base includes a plurality of gas cooking fuel burner tubes that are positioned beneath the cooking surface and slidable drawer. The slidable drawer includes a preferably rippled tray having a plurality of passages therein that allow spent solid fuel held therein and drippings from the cooking surface to fall through the passages in the troughs of the rippled tray such that the fallings do not impact the gas burner tubes.

There can also be an ash collection chute under the gas burner tubes that includes a downwardly angled slope that ends with an ash collection box. The chute is at least partially within the base and can slide out of grill base with the ash collection box remaining fully slid into the bottom of the chute. The ash collection box itself can be embodied so as to independently slide into and out from the ash collection chute. The ash collection chute can also be downwardly asymmetrical to allow a fuel tank for the gas burner tubes to fit within the base of the grill vertically underneath the ash collection chute.

In one embodiment, there can be an extendable shield that selectively extends under the slidable drawer as it extends from the grill base. In one embodiment, the extendable shield telescopes out as the slidable drawer is pulled out, which prevents combusting fuel or spent fuel from falling on the floor or feet of the user.

The grill can be embodied as having four wheels on its base, or have two wheels and a rolling fulcrum, or can have no wheels at all and be stationary. Furthermore, there can be side burners or other cooking accessories either integrated with or attached to the grill structure. There also can be multiple slidable drawers in vertical and/or horizontal alignment between the cooking surface and burner tubes.

### BRIEF DESCRIPTION OF THE DRAWINGS

FIG. 1 is a perspective view of the dual fuel grill showing the slidable drawer for solid fuel partially slid out from the grill.

FIG. 2 is a perspective rear view of the dual fuel grill of FIG. 1.

FIG. 3 is a cut-away view of the rear of the dual fuel grill illustrating the rippled tray of the drawer in situ over the burner tubes.

FIG. 4 is a close-in view of the rippled tray and burner tubes of FIG. 3.

FIG. 5 is a rear view of the dual fuel grill of FIG. 2, showing the ash collection chute partially slid out from the rear of the grill with the ash collection box remaining fully slid into the chute.

FIG. 6 is a perspective view of the solid fuel drawer showing the rippled tray that supports the solid cooking fuel.

FIG. 7A is a perspective view of one embodiment of the grill having a extendable shield that can be extended under the slidable drawer as it is pulled out of the grill base.

FIG. 7B is a perspective view of the embodiment of FIG. 7A with the slidable drawer partly inserted into the grill body, with the extendable shield partially extended and covering the bottom of the slidable drawer.

### DETAILED DESCRIPTION

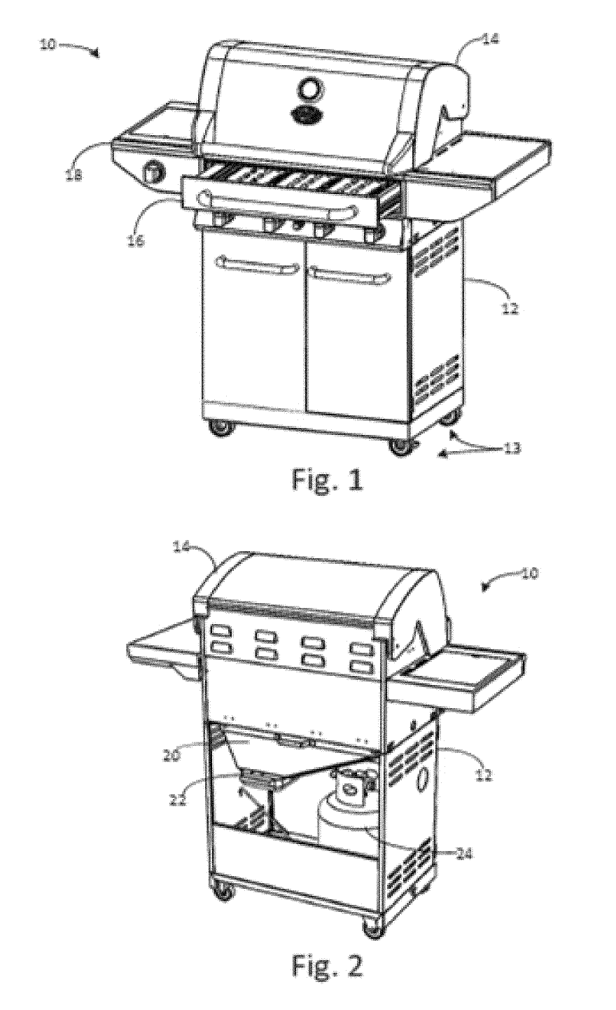

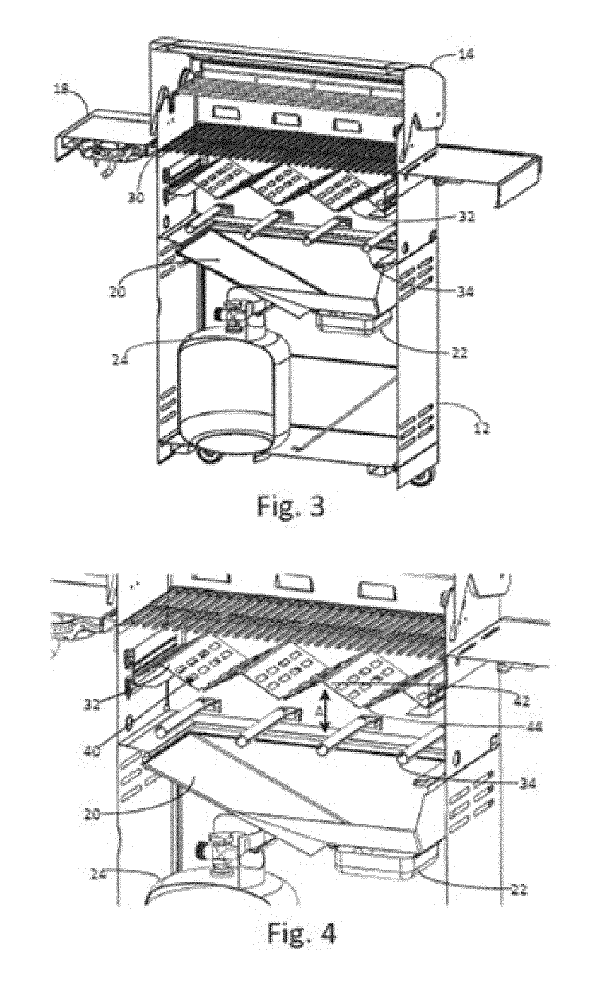

With reference to the drawings in which like numerals represent like elements throughout the several views, FIG. 1 is a perspective view of the dual fuel grill 10 showing the slidable drawer 16 for solid fuel partially slid out from the grill base 12. A movable lid 14 selectively covers a cooking surface 30 (FIG. 3). The grill 10 here is embodied with a side burner 18 integrated with the grill structure above the base 12. Other cooking units can be used other than a side-burner, such as a smoker, side firebox, or griddle. The grill 10 is typically constructed from metal for heat and flame resistance purposes, but certain parts of the grill 10 can also be made from other materials such as wood or plastic.

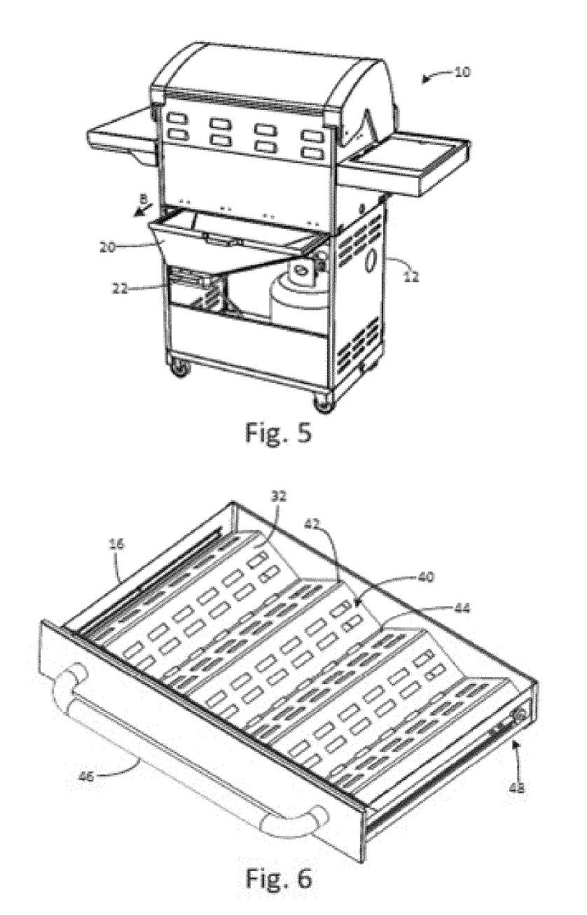

FIG. 2 is a perspective rear view of the dual fuel grill 10 showing an as ash collection chute 20 under the gas burner tubes 34 (FIG. 3) that includes a downwardly angled slope that ends with an ash collection box 22. The chute 20 is at least partially within the base 12 and can slide out of grill base 12 with the ash collection box 22 remaining fully slid into the chute 20. This feature is more clearly shown in FIG. 5. The ash collection box 22 itself can be embodied so as to independently slide into and out from the ash collection chute 20. The ash collection chute 20 can also be downwardly asymmetrical to allow a fuel tank 24 for the burner tubes 30 to fit within the base 12 of the grill 10 vertically underneath the ash collection chute 20. Thus, in one embodiment, the ash collection chute 20 can create sufficient space to mount a standard 20 lb LP cylinder in the grill base 12.

FIG. 3 is a cut-away view of the rear of the dual fuel grill 10 illustrating the rippled tray 32 of the drawer 16 in situ over the burner tubes 34. As shown, the grill structure includes a cooking surface 30, a movable cover 14 over the cooking surface 30, with a slidable drawer 16 and its rippled tray 32. The grill 10 does not include a cover and can simply be open. The base includes one or more gas cooking fuel tube burners 34 that are positioned beneath the cooking surface 30 and slidable drawer 16.

FIG. 4 is a close-in view of the rippled tray 32 and burner tubes 34 of FIG. 3. The slidable drawer 16 includes a rippled tray 32 having a plurality of passages 40 therein that allow spent solid fuel held in the drawer 16 and on the rippled tray 32 and drippings from the cooking surface 30 to fall through openings 40 around the troughs 44 of the rippled tray 16 such that the fallings do not impact the gas burner tubes 34. The peaks 42 are in vertical alignment with each burner tube 34 as shown by Arrow A. The passages 40 are positioned in slanted alignment beneath the peaks 42 and extend down into the troughs 44 of the rippled tray 32 such that drippings and spent fuel, ash, or “debris” generally, will slide from the peak 42 to the one of the openings 40 that can extend all the way into the trough 44. Through this design, the drippings, spent fuel (such as ash), and/or other debris, will not substantially hit or impact the burner tube 34 directly. Thus, the grill 10 can use standard extrusion tube burners to provide heat, as opposed to specialized cast burners that have a “roof” design over the top of the burner to minimize ash build-up, as known in the prior art. The rippled tray 32 is shown only in one embodiment here, and the specific distance between peaks 42 and troughs 44 can be varied, along with the rippling being very slight (virtually flat) to very great.

FIG. 5 is a rear view of the dual fuel grill 10 of FIG. 2, showing the ash collection chute 20 partially slid out from the rear of the grill base 12 in the direction of Arrow B with the ash collection box 22 remaining fully slid into the chute 20. The ash collection box 22 can be slidable and removable from the chute 20 to allow the carrying and dumping of ashes, drippings, etc., that are directed into it from the downward angles of the chute 20.

FIG. 6 is a perspective view of the solid fuel drawer 16 showing the rippled tray 32 that supports the solid cooking fuel. The drawer 16 is embodied here as having a handle 46, which can have insulation or not, that allows it to be slid into and out of the grill 10 and under the cooking surface 30. The rippled tray 32 shows the peaks 42 and troughs 44 with the plurality of openings 40 focused on the troughs 44 to have gravity drive the spent fuel and drippings through the openings 40 thereby avoiding the burner tubes 34 that are vertically aligned under the peaks 42. The drawer 16 can include simple slides 48, such as those used for kitchen cabinet drawers, or can be embodied with a more elaborate and custom slide as warranted. For example, the slide could be reinforced to allow the use of heavy solid fuel within the drawer 16. All components of the drawer 16 and sliding mechanism should be made from flame and heat resistant materials.

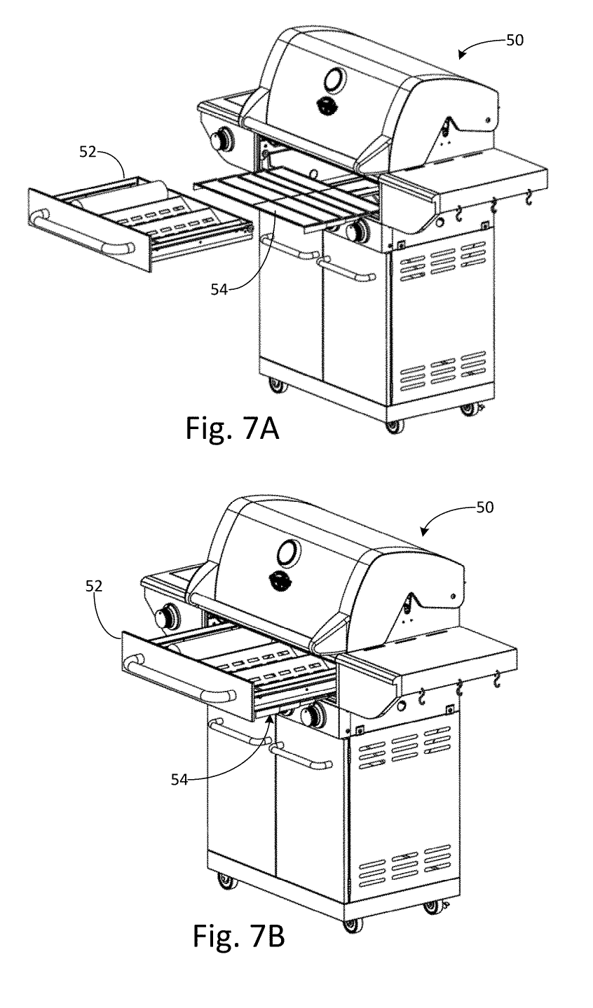

FIG. 7A is a perspective view of one embodiment of the grill 50 having an extendable shield 54 that can be extended between under the bottom of the slidable drawer 52 as it is pulled out from the grill base 12. In this embodiment, the extendable shield 54 is embodied as a series of interlocked and telescoping plates that are anchored to the grill base 12 and selectively are pulled out from the front of the slidable drawer 52 to cover the bottom of the rippled tray 32. The extendable shield 54 is preferably made from metal or other hard flame and heat resistant material. The material should also have some corrosion resistance against water or food droppings, or other admixtures of spent fuel such as ash and organic residue that can be very alkaline.

The extendable shield 54 allows a user of the grill 50 to pull out the slidable drawer 52 without having to worry that debris, such as spent fuel and food drippings, may fall through the slidable drawer 52 and onto the floor or feet of the user. Because the extendable shield 54 telescopes, the bottom of the slidable drawer 52 will become uncovered once it is slid back into the grill base 12 and debris is then free to fall off of the telescoped extendable shield 54 into the ash collection chute 20.

FIG. 7B is a perspective view of the embodiment of FIG. 7A with the slidable drawer 52 partly inserted into the grill body, with the extendable shield 54 extended and covering the bottom of the slidable drawer 52. Other configurations that a telescoping plate arrangement can also be used to extend the extendable shield 54 including simple mechanical pushing and pulling, selectively latching the extendable shield 54 on the front of the slidable drawer 52, and a separate mechanical or electrical motor can also motivate the shield within the grill base 12 such that the extendable shield 54 will operate with the opening and closing of the slidable drawer 52.

With reference again to FIG. 1, the grill 10 can be embodied as having four wheels 13 on its base 12, or have two wheels and a rolling fulcrum, or can have no wheels at all and be stationary. Furthermore, as noted above, there can be a side burner 18 as shown, or other cooking accessories either integrated with or attached to the grill structure, such as side fire boxes and smoker boxes as are known in the art, and that cooking accessory can use the same source of gas for the burner tubes 34, have a separate electric cord, or utilize its own burning fuel.

There also can be multiple slidable drawers in vertical and/or horizontal alignment (e.g. side-by-side) between the cooking surface 30 and burner tubes 34. Through such arrangement different types of solid cooking fuels, such as flavoring wood and charcoal could be used beneath the cooking surface 30. In such embodiment, the peaks 42 and troughs 44 of each drawer 16 would be vertically aligned to protect the burner tubes 34.

While the present invention has been shown in several embodiments with various elements described, it should be appreciated that changes can be made in the arrangements of the elements and function of the grill without departing from the spirit and scope of the invention as is particularly set forth in the claims.

What is claimed is:

1. A grilling structure, comprising:
a grill body having a grill base, the body including at least one cooking surface;
at least one slidable drawer selectively slidable into the grill base, the at least one slidable drawer further including a solid fuel tray having a plurality of passages therethrough, and further configured to support burning solid fuel on the solid fuel tray; and
at least one gas burner tube within the grill base that is positioned beneath the at least one slidable drawer when that slidable drawer is within the grill base, the at least one gas burner tube positioned in the grill base such that the plurality of passages in the solid fuel tray of the slidable drawer are substantially vertically positioned above the at least one burner tube such that debris that falls through the passages of the at least one slidable drawer does not substantially impact the at least one gas burner tube.

2. The grilling structure of claim 1, wherein the solid fuel tray of the at least one slidable drawer is rippled and includes a plurality of troughs therein, and the passages in the solid fuel tray are positioned in the troughs such that debris impacting the solid fuel tray falls down one or more of the plurality of troughs and falls through the plurality of passages and does not substantially impact the at least one gas burner tube.

3. The grilling structure of claim 1, further comprising a movable cover selectively covering the cooking surface.

4. The grilling structure of claim 1, further comprising an extendable shield under the at least one slidable drawer that selectively extends under the at least one slidable drawer as it extends outwardly from the grill base.

5. The grilling structure of claim 1, further including an ash collection chute within the grill base under the at least one gas burner tube, the ash collection chute including a downwardly angled slope into an ash collection box.

6. The grilling structure of claim 5, wherein:
the ash collection chute is slidable out of grill base; and
the ash collection box is independently slidable out of the ash collection chute.

7. The grilling structure of claim 1, wherein the at least one gas burner tube and cooking surface comprise a first cooking unit, and further including a second cooking unit in the grill body that operates independently from the first cooking unit.

8. The grilling structure of claim 1, further comprising at least two slidable drawers between the cooking surface and at least one gas burner tube where each slidable drawer being substantially vertically positioned above at least one of the plurality of burner tubes such that debris that falls through the plurality of passages of each slidable drawer does not substantially impact the at least one gas burner tube.

9. A multiple cooking unit grilling structure, comprising:
a grill body having a grill base, the body including at least one cooking surface;
at least one slidable drawer selectively slidable into the grill base, the at least one slidable drawer further including a rippled tray having a plurality of passages therethrough, and further configured to support burning solid fuel on the rippled tray;
a plurality of gas burner tubes within the grill base that are positioned beneath the at least one slidable drawer when that slidable drawer is within the grill base, the plurality of gas burner tubes positioned in the grill base such that the plurality of passages in the slidable drawer are substantially vertically positioned above at least one of the plurality of burner tubes such that debris that falls through the passages of the at least one slidable drawer does not substantially impact the plurality of gas burner tubes;
wherein the at least one slidable drawer, gas burner tubes and cooking surface comprise a first cooking unit; and
the grill body further including a second cooking unit in the grill body that operates independently from the first cooking unit.

10. The multiple cooking unit grilling structure of claim 9, wherein the rippled tray of the at least one slidable drawer includes a plurality of troughs therein, and the passages in the rippled tray are positioned in the troughs such that debris impacting the rippled tray falls down one or more of the plurality of troughs and falls through the plurality of passages and does not substantially impact the plurality of gas burner tubes.

11. The multiple cooking unit grilling structure of claim 9, wherein the first cooking unit further includes a movable cover selectively covering the cooking surface.

12. The multiple cooking unit grilling structure of claim 9, wherein the first cooking unit further includes an extendable shield within the grill base that selectively extends under the least one slidable drawer as it extends outwardly from the grill base.

13. The multiple cooking unit grilling structure of claim 9, further including an ash collection chute within the grill base under the plurality of gas burner tubes, the ash collection chute including a downwardly angled slope into an ash collection box.

14. The multiple cooking unit grilling structure of claim 13, wherein:
the ash collection chute is slidable out of grill base; and
the ash collection box is independently slidable out of the ash collection chute.

15. The multiple cooking unit grilling structure of claim 1, further comprising at least two slidable drawers between the cooking surface and burner tubes where each slidable drawer being substantially vertically positioned above at least one of the plurality of burner tubes such that debris that falls through the plurality of passages of each slidable drawer does not substantially impact the plurality of gas burner tubes.

16. A grilling structure, comprising:
a grill body having a grill base, the body including at least one cooking surface;
a first means for holding combustible solid fuel beneath the at least one cooking surface, the first means externally accessible from the grill base, the first means further including a second means for allowing debris to fall through the first means;
a third means for burning gas beneath the first means and at least one cooking surface; and
wherein the third means further being positioned in the grill base such that the second means is substantially vertically positioned above the third means such that debris that falls through the second means does not substantially impact the third means.

17. The grilling structure of claim 16, further including a cover means for selectively covering the cooking surface.

18. The grilling structure of claim 16, further comprising a shield means for selectively extending a barrier under the first means as it extends outwardly from the grill base.

19. The grilling structure of claim 16, further including waste collection means for collecting debris that falls through the second means and past the third means, the waste collection means located within the grill base.

20. The grilling structure of claim 16, further including a fourth means for cooking that operates independently from the first means and second means, the fourth means located on the grill body.
